(19) United States
(12) Patent Application Publication
(10) Pub. No.: US 2012/0163647 A1
(43) Pub. Date: Jun. 28, 2012

(54) MICROPHONE-AND-EARPHONE SET WITH FUNCTIONS OF WIRE ARRANGEMENT AND WINDING

(76) Inventor: Han-Hsiang Chang, Taoyuan Hsien (TW)

(21) Appl. No.: 13/089,327

(22) Filed: Apr. 19, 2011

Related U.S. Application Data
(63) Continuation-in-part of application No. 12/978,656, filed on Dec. 27, 2010, now abandoned.

(51) Int. Cl. H04R 1/10

(52) U.S. Cl. 381/375

(57) ABSTRACT

A microphone and earphone set with functions of wire arrangement and winding has at least one earphone which is connected with an audio wire and a wire arranging box which is a hollow casing. The audio wire movably passes through the box. When the audio wire of the earphone is stored completely, the earphone rests upon the box to be fixed thereon. A microphone is installed in the box and is extended out with a signal wire. A plug serves to be connected with the signal wire and the audio wire for signal transmission and power supply. The wires of the earphone and microphone can be arranged easily.

The present invention is a continuation in part of U.S. patent application Ser. No. 12/978,656 which is assigned to and invented by the inventor and applicant of the present invention. Thus, the content of U. S. Patent Application No. No. 12/978,656 is incorporated into the present invention as a part of the present invention.

### MICROPHONE-AND-EARPHONE SET WITH FUNCTIONS OF WIRE ARRANGEMENT AND WINDING

1. Field of the Invention

The present invention relates to earphone devices, and in particularly to a microphone-and-earphone set with functions of wire arrangement and winding.

2. Background of the Invention

Currently, electronic devices are more and more popular and widely used in daily life. Therefore, portable electronic devices with audio functions are frequently used with earphones. Currently, since the earphone wires are very long and thus are difficult to be arranged in order. It is often that the wires are disorder in winding. In next use, the users must take time to rearrange the wires. It is very inconvenient. Moreover, if the earphone wires are pulled in force many times, they are easy to be damaged so as to reduce the lifetime of the earphone.

To avoid the above mentioned problem, there is a kind of earphones with easy-to-store wires. This earphone is formed by a set of earphones and a storage device. When the earphones are not in use, the wires are arranged manually in the storage device. The storage device and the earphones are formed separately instead of being integrally formed. Thus they are easy to lose. Moreover, the wires of the earphones are not put together with the microphone, so they can only be stored separately.

### SUMMARY OF THE INVENTION

The object of the present invention is to resolve the prior art problem. The present invention provides a microphone-and-earphone set with functions of wire arrangement and winding. The present invention can be used on electronic devices such as handsets, iPads, and so on. The wires of the earphones and the microphone can be arranged easily. A microphone is stored in a wire arranging box, and two audio wires of the earphones are movable along the wire arranging box. When a user wants to wear the earphones, the wire arranging box separates from the two earphones, and the microphone is located near the mouth of the user. When the wires are to be arranged in order, the two earphones rest on an outer side of the wire arranging box. At this state, the two audio wires and the microphone signal wire are arranged in parallel so that the wire bank can be wound around the wire storage device and thus all the wires can be stored in order easily.

To achieve above object, the present invention provides a microphone and earphone set with functions of wire arrangement and winding has at least one earphone which is connected with an audio wire and a wire arranging box which is a hollow casing. The audio wire movably passes through the box. When the audio wire of the earphone is stored completely, the earphone rests upon the box to be fixed thereon. A microphone is installed in the box and is extended out with a signal wire. A plug serves to be connected with the signal wire and the audio wire for signal transmission and power supply.

The various objects and advantages of the present invention will be more readily understood from the following detailed description when read in conjunction with the appended drawings.

### BRIEF DESCRIPTION OF THE DRAWINGS

FIG. 1 is a schematic view of the present invention, wherein the wires are fully-extended.

FIG. 2 is another schematic view of the present invention, wherein the wires are halfway-extended.

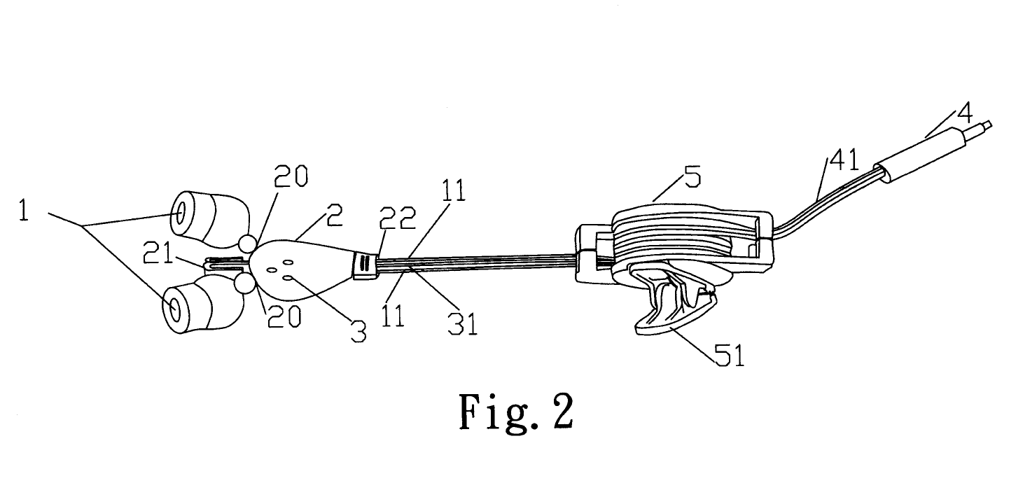

FIG. 3 is a further schematic view of the present invention, wherein the wires are fully wound around the winding box.

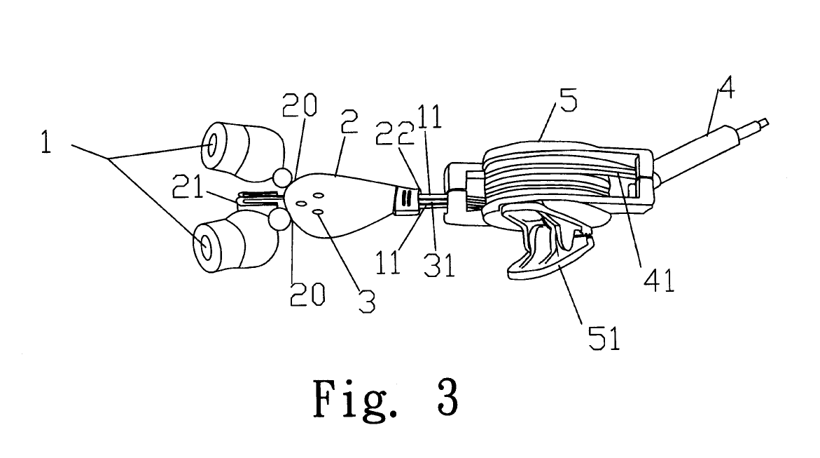

FIG. 4 is a schematic view showing the state of the earphones and the wire arranging box when the microphone-and-earphone set of the present invention is in use.

FIG. 5 is another schematic view showing the state of the earphones and the wire arranging box when the microphone-and-earphone set of the present invention is not in use.

### DETAILED DESCRIPTION OF THE INVENTION

In order that those skilled in the art can further understand the present invention, a description will be provided in the following in details.

However, these descriptions and the appended drawings are only used to cause those skilled in the art to understand the objects, features, and characteristics of the present invention, but not to be used to confine the scope and spirit of the present invention defined in the appended claims.

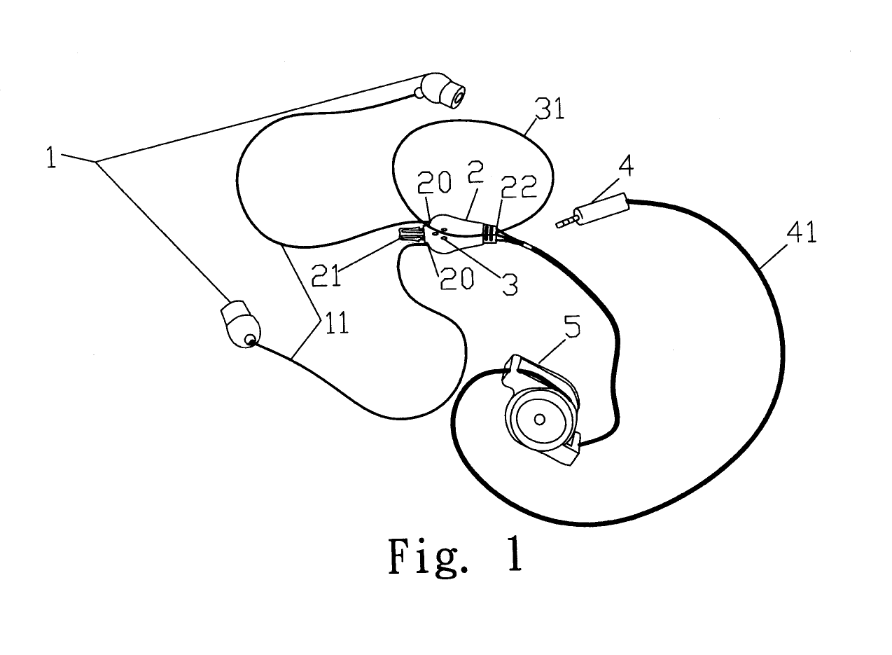

With reference to FIG. 1, the microphone-and-earphone set with functions of wire arrangement and winding of the present invention is illustrated. The present invention includes the following elements.

A pair of earphones 1 is included. Each earphone 1 is connected with an audio wire 11.

A wire arranging box 2 has a hollow space therein. An upper end of the wire arranging box 2 is formed with two wire holes 20 which are communicated to the hollow space. A lower end of the wire arranging box 2 is formed with one through hole 22 which is communicated to the hollow space therein. The upper end of the wire arranging box 2 is formed with a hanging buckle 21.

The two audio wires 11 pass through the two wire holes 20 of the wire arranging box 2 and extend through the hollow space to leave the wire arranging box 2 from the through hole 22. When the two audio wires 11 are pulled fully from one end, the earphones 1 will rest against an outer wall of the wire arranging box 2 so as to be fixed thereon.

A microphone 3 is located in the wire arranging box 2. The microphone 3 is connected with a microphone signal wire 31. The microphone signal wire 31 passes through the through hole 22 to leave out of the wire arranging box 2.

A plug 4 has one end connected with the microphone signal wire 31 and the two audio wires 11. The microphone signal wire 31 and the two audio wires 11 are combined to form a wire bank 41. When the plug 4 is plugged into an electronic device (not shown), the signals are transmitted between the electronic device and the two earphones 1 and the microphone 3.

Power can be provided to the microphone 3 and the earphones 1 through the plug 4 and the wire bank 41.

A wire storage device 5 serves for storing the wire bank 41. In this embodiment, a wire winding box is used as an example. The wire bank 41 winds around the wire storage device 5 and then leaves the wire storage device 5. The wire storage device 5 can store the wire bank 41 by winding the wire bank 41 around the wire storage device 5. However, the wire storage device 5 are known in the prior art and the details will not be described herein. Furthermore, it should be noted that the form of the wire storage device 5 is not limited to the form illustrated in the drawings. Other forms are also permissible. All these are within the scope of the present invention.

Moreover, in the present invention, one lateral side of the wire storage device 5 has a clip 51 for clipping the wire storage device 5 on clothes.

It should be emphasized that the components of the present invention are not confined to those illustrated in the drawings. The shapes, forms, and colors are not limited in the present invention.

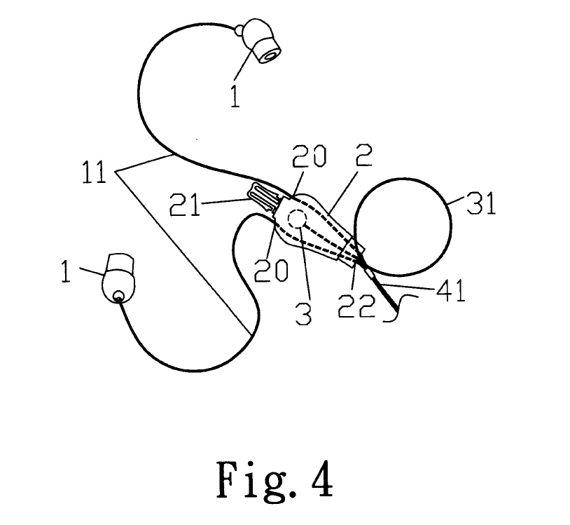

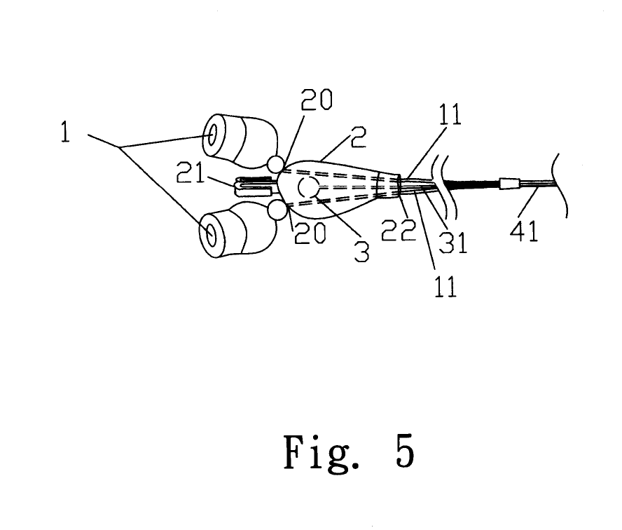

In the present invention the earphones are suitable for handsets, iPads and other electronic devices. The present invention provides the convenience that the wires of the earphones 1 and the microphone 3 can be stored in order. Referring to FIGS. 4 and 5, it shows the application of the present invention, in that the two audio wires 11 move along the wire arranging box 2 containing the microphone 3 therein. When a user wants to wear the earphones 1, the two earphones 1 separate from the wire arranging box 2, while the microphone 3 is located near the mouth of the user. When the wires are to be stored, the two earphones 1 are located against the wire arranging box 2. At this state, the two audio wires 11 and the microphone signal wire 31 are arranged in parallel so that the wire bank can be wound around the wire storage device 5 easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A microphone-and-earphone set with functions of wire arrangement and winding comprising:
at least one earphone connected to an audio wire;
a wire arranging box being a hollow casing;
wherein the audio wires movably passing through the wire arranging box; as the audio wires are pulled fully from one end, the earphones rest upon the wire arranging box for being fixed thereon;
a microphone located within the wire arranging box and extended with a microphone signal wire which extends out of the wire arranging box; and
a plug having one end connected with the two audio wires and the microphone signal wire for signal and power transmission.

2. The microphone-and-earphone set with functions of wire arrangement and winding as claimed in claim 1, wherein one end of the wire arranging box has at least one wire hole and another end of the wire arranging box has one through hole; the audio wire passes through the wire hole and then passes through the through hole with the microphone signal wire.

3. The microphone-and-earphone set with functions of wire arrangement and winding as claimed in claim 1, wherein the at least one ear portion protrudes from the wire arranging box and the audio wire passes through the ear portion.

4. The microphone-and-earphone set with functions of wire arrangement and winding as claimed in claim 1, further comprising a wire storage device for storing the audio wires and the microphone signal wire.

5. The microphone-and-earphone set with functions of wire arrangement and winding as claimed in claim 4, wherein the wire storage device is a wire winder for winding the audio wires and the microphone signal wire around a wheel of the wire winder.

6. The microphone-and-earphone set with functions of wire arrangement and winding as claimed in claim 1, wherein the audio wire and microphone signal wire are combined as a wire bank.

7. The microphone-and-earphone set with functions of wire arrangement and winding as claimed in claim 6, wherein the wire bank serves to transfer power for driving the microphone and the earphone.

8. The microphone-and-earphone set with functions of wire arrangement and winding as claimed in claim 1, wherein a hanging buckle is installed on an outer side of the wire arranging box so that the wire arranging box can be hung upon an object.

9. The microphone-and-earphone set with functions of wire arrangement and winding as claimed in claim 1, wherein a lateral side of the wire storage device has a clip for clipping the wire storage device on clothes.

10. The microphone-and-earphone set with functions of wire arrangement and winding as claimed in claim 1, wherein there are two earphones and two wire holes; and the two audio wires pass through the two wire holes, respectively, and then pass through the through hole with the microphone signal wire.
